(19) United States
(12) Patent Application Publication
(10) Pub. No.: US 2021/0309923 A1
(43) Pub. Date: Oct. 7, 2021

(54) PROCESS FOR DESULFURIZATION OF HYDROCARBONS

(71) Applicant: HALDOR TOPSØE A/S, Kgs. Lyngby (DK)

(72) Inventor: Christian Ejersbo STREBEL, Birkerød (DK)

(73) Assignee: HALDOR TOPSØE A/S, Kgs. Lyngby (DK)

(21) Appl. No.: 17/054,544

(22) PCT Filed: May 28, 2019
(86) PCT No.: PCT/EP2019/063794

§ 371 Date: Nov. 11, 2020

(30) Foreign Application Priority Data
May 30, 2018 (DK) PA 2018 00243

(51) Int. Cl. C10G 45/08; C10G 45/32; C10G 65/06; C10G 65/16; B01J 23/882; B01J 35/02

(52) U.S. Cl. CPC C10G 45/08; C10G 2400/22; C10G 65/06; C10G 65/16; B01J 23/882; B01J 35/023; B01J 35/026; C10G 2300/202; C10G 2300/301; C10G 2300/1044; C10G 2300/305; C10G 2300/4006; C10G 2300/4012; C10G 2300/4018; C10G 2300/70; C10G 45/32

(57) ABSTRACT

A process for hydrodesulfurizing an olefinic naphtha feedstock while retaining a substantial amount of the olefins, which feedstock has a T₉₅ boiling point below 250° C. and contains at least 50 ppmw of organically bound sulfur and from 5% to 60% olefins, the process including hydrodesulfurizing the feedstock in a sulfur removal stage in the presence of a gas including hydrogen and a hydrodesulfu-rization catalyst, at hydrodesulfurization reaction conditions, to convert at least 60% of the organically bound sulfur to hydrogen sulfide and to produce a desulfurized product stream, with the associated benefit of such a process providing a lower octane loss at all severities above 60% HDS, compared to a process with similar conversion of organic sulfur with a lower gas to oil ratio, as measured by the selectivity slope, while avoiding excessive increase of equipment size by limiting gas to oil ratio.

### TECHNICAL FIELD

The present invention relates to a process for the selective hydrodesulfurization of naphtha streams containing sulfur and olefins. An olefinic naphtha stream is hydrodesulfurized at a high gas to oil ratio, resulting in effective hydrodesulfurization and maintenance of octane values.

### BACKGROUND

The requirements to sulfur levels in gasoline have continually been increased, recently to below 10 ppmw. In general, this will require deep desulfurization of olefinic naphthas. Deep desulfurization of naphtha requires improved technology to reduce sulfur levels without the severe loss of octane number that accompanies the undesirable saturation of olefins.

Hydrodesulfurization is a hydrotreating process for the removal of feed sulfur by conversion to hydrogen sulfide. Conversion is typically achieved by reaction of the feed with hydrogen over non-noble metal sulfided supported and unsupported catalysts, especially those of Co/Mo and Ni/Mo. Severe temperatures and pressures may be required to meet product quality specifications by conventional means.

Olefinic cracked naphthas and coker naphthas typically contain more than about 20 weight percent olefins. At least a portion of the olefins are hydrogenated during conventional hydrodesulfurization. Since olefins are relatively high octane number components, it is desirable to retain the olefins rather than to hydrogenate them to saturated compounds. Conventional hydrodesulfurization catalysts have both hydrogenation and desulfurization activity. Hydrodesulfurization of cracked naphthas using conventional naphtha desulfurization catalysts under conventional conditions required for sulfur removal, results in a significant loss of olefins through hydrogenation. This results in a lower grade fuel product that needs additional refining, such as isomerization, catalytic reforming, blending, etc., to produce higher octane fuels. This, of course, adds significantly to production costs.

Selective hydrodesulfurization involves removing sulfur while minimizing hydrogenation of olefins and octane reduction by various techniques, such as selective catalysts, separation of feedstocks, with individual treatments of fractions at specific process conditions, or both.

In regular hydrodesulfurization processes, the gas to oil ratio (GOR) is typically kept below 500 Nm³/m³ since it has been believed that higher GOR will push the reaction towards a higher hydrogenation of the olefins. In addition, there has been little motivation to increase GOR, as a higher GOR will be related with additional cost due to a requirement for excess hydrogen circulation in the process, and an elevated consumption of hydrogen by reactions forming products without increased value has also been assumed. The typical pressure for such processes have been around 20-25 barg, in an expectation of lower catalyst deactivation compared to lower pressures. In addition, 20-25 barg is also a common hydrogen supply pressure.

### SUMMARY AND DESCRIPTION

It has however, now surprisingly been discovered that GOR above 500 Nm³/m³ in combination with moderate absolute pressures, contrary to expectations will have the effect of enabling a higher desulfurization with reduced loss of octane numbers. The selectivity balance between hydrodesulfurization and the hydrogenation of olefins is a possible definition of the overall quality of a FCC naphtha post-treat process. In U.S. Pat. No. 7,629,289 the best performing catalyst was able to obtain a selectivity of 6.5, and processes obtaining more than 60-80% level of hydrodesulfurization are typically performing at or below such a selectivity.

The present invention is a process enabling an improved selectivity towards hydrodesulfurization over hydrogenation of olefins, by increasing the GOR and limiting the pressure, which is commercially attractive, since the value of naphtha is highly related to the octane number. Traditionally the octane number has been maintained by providing process modifications increasing the complexity of processes or by development of complex specific catalysts.

The gas to oil ratio shall in accordance with the terminology of the skilled person of refinery technology in the following be construed to mean the ratio between hydrogen containing gas and naphtha feedstock, as determined by the individual flows of the streams at the point where the hydrogen containing gas and the feedstock are mixed.

In the present text the term GOR is used as an abbreviation for the gas to oil ratio. The two terms shall be construed as fully equivalent. The unit for GOR is given as Nm³/m³. The numerator of the unit (Nm³) shall be understood as “normal” m³, i.e. the amount of gas taken up this volume at 0° C. and 1 atmosphere and the denominator of the unit (m³) shall be understood as the volumetric flow of oil at standard conditions, typically at 60° F. and 1 atmosphere.

The pressure and temperature shall in accordance with the terminology of the skilled person of refinery technology in the following be construed as the pressure and temperature respectively at the inlet of a reactor.

The hydrogen partial pressure shall be construed as the partial pressure of hydrogen in the treat gas.

The space velocity shall in accordance with the terminology of the skilled person of refinery technology in the following be construed as the LHSV (liquid hourly space velocity) over a single catalytically active material unless otherwise indicated.

The initial boiling point (IBP), the final boiling point (FBP) and the temperatures corresponding to recovered amounts of sample, shall be understood in accordance with the ASTM D86 standard. T₅, T₁₀, T₅₀ and T₉₅ boiling points shall accordingly be understood as the distillation temperatures where 5 vol %, 10 vol %, 50 vol % and 95 vol % respectively have been recovered.

The research octane number (RON) shall be understood as the octane number measured in accordance with ASTM D2699.

Olefins shall in accordance with the IUPAC definition and the language of the skilled person be understood as acyclic and cyclic hydrocarbons having one or more carbon-carbon double bonds.

Di-olefins shall similarly be understood as acyclic and cyclic hydrocarbons having two or more carbon-carbon double bonds.

The severity of reaction conditions shall be understood as the extent to which a given reaction will take place. Hydrodesulfurization severity, shall be understood as being increased if one or more physical or chemical conditions are changed in a way having the consequence that the degree of hydrodesulfurization is increased.

Where concentrations are stated in vol % or ppmv this shall be understood as volume/volume % and volume/volume parts per million.

Where concentrations are stated in wt % or ppmw this shall be understood as weight/weight % and weight/weight parts per million.

Where an amount of sulfur is specified, this shall be construed as the wt % of atomic sulfur, relative to the total stream.

Where an amount of organic sulfur is specified, this shall be construed as the wt % of atomic sulfur in organic molecules, relative to the total stream.

The term conversion shall be construed as the net conversion, as calculated from the inlet concentration of a species and the outlet concentration of a species relative to the inlet concentration of the species.

The terms extent of hydrodesulfurization, HDS conversion or % HDS shall be considered equivalent, unless stated otherwise, and shall be construed as the net conversion of organic sulfur to inorganic sulfur, as calculated from the wt % of atomic sulfur in organic molecules (e.g. excluding H₂S) in the inlet stream and the outlet stream.

The terms extent of hydrogenation of olefins, olefin saturation or % OSAT shall be considered equivalent, unless stated otherwise, and shall be construed as the net conversion of olefins, as calculated from the wt % of olefinic molecules in the inlet stream and the outlet stream.

The term selectivity shall be construed as the ratio between the extent of hydrodesulfurization and the extent of hydrogenation of olefins, e.g. % HDS/% OSAT.

A broad aspect of the present disclosure relates to a process for hydrodesulfurizing an olefinic naphtha feedstock while retaining a substantial amount of the olefins, which feedstock has a T₉₅ boiling point below 250° C. and contains at least 50 ppmw of organically bound sulfur and from 5% to 60% olefins, said process comprising hydrodesulfurizing the feedstock in a sulfur removal stage in the presence of a gas comprising hydrogen and a hydrodesulfurization catalyst, at hydrodesulfurization reaction conditions including a temperature from 200° C. to 350° C., a pressure from 2 barg or 5 barg to 10 barg, 15 barg, 25 barg or 35 barg, and gas to oil ratio from 500 Nm³/m³, 600 Nm³/m³, 700 Nm³/m³ or 750 Nm³/m³ to 900 Nm³/m³ or 1000 Nm³/m³, to convert at least 60% of the organically bound sulfur to hydrogen sulfide and to produce a desulfurized product stream, with the associated benefit of such a process providing a lower octane loss at all severities above 60% HDS, compared to a process with similar conversion of organic sulfur with a lower gas to oil ratio, as measured by the selectivity slope, (% HDS-% OSAT)/(% OSAT*(100-% HDS)), while avoiding excessive increase of equipment size by limiting gas to oil ratio.

In a further embodiment the process severity is configured for converting at least 70%, 80% or 90% of the organically bound sulfur to hydrogen sulfide, with the associated benefit of providing a process suitable for current sulfur regulation with minimal octane loss.

In a further embodiment the gas to oil ratio and the pressure is configured for the selectivity slope, (% HDS-% OSAT)/(% OSAT*(100-% HDS)), to be above 0.55 or 0.7, with the associated benefit of obtaining desirable process configurations under the guidance of the parameter selectivity slope.

In a further embodiment less than 30% or 50% of the sulfur in the feedstock directed to the sulfur removal stage is found in mercaptans. Such a feedstock would be in need of a severe but specific hydrodesulfurization. The guidance of the selectivity slope is especially suitable for such a more difficult feedstock, typically be found in FCC products, not having undergone significant hydrodesulfurization.

In a further embodiment the liquid hourly space velocity (LHSV) is from 1.1 hr⁻¹ to 3 hr⁻¹, with the associated benefit of a low LHSV being a possibility to employ the increased selectivity by an increase in process severity, without sacrificing olefins.

In a further embodiment the process further comprises the steps of:
b) separating the feedstock in at least a heavy naphtha stream and a light naphtha stream according to boiling point;
c) directing said heavy naphtha stream as the feedstock of said hydrodesulfurizing step, providing a desulfurized product stream;
d) optionally directing the light naphtha stream as the feedstock to a further sulfur removal stage, providing a light desulfurized naphtha stream; and
e) combining said desulfurized product stream and either said light naphtha stream or said light desulfurized naphtha stream to form a final product stream,
   with the associated benefit of such a process having a lower octane loss compared to a similar process without separation of the feedstock.

In a further embodiment said hydrodesulfurization catalyst comprises 0.5% or 1% to 5% cobalt and/or nickel and 3% to 20% molybdenum and/or tungsten, on a refractory support, with the associated benefit of such a catalyst being cost effective for hydrodesulfurization.

In a further embodiment said hydrodesulfurization catalyst comprises 0.5% or 1% to 5% cobalt and 3% to 20% molybdenum with the associated benefit of such a catalyst being cost effective for hydrodesulfurization and having limited activity in olefin saturation.

In a further embodiment said refractory support comprises alumina, silicaspinel or silica-alumina, with the associated benefit of such a support being highly robust. Alumina and silica shall be construed as materials of synthetic or natural origin being dominated by the oxides of aluminum and silicium. Alumina-silica shall be construed as a mixture, in any ratio, on any level down to atomic level of these oxides. Spinel shall be construed as an oxidic material comprising magnesium and aluminum in a common crystal structure.

In a further embodiment said step (c) comprises the substeps:
(x) directing said heavy naphtha stream as the feedstock of a first hydrodesulfurizing step, providing a desulfurized heavy product stream;
(y) optionally separating the desulfurized heavy product stream in a at least a desulfurized heavy naphtha stream and a gas stream; and
(z) further desulfurizing the heavy desulfurized naphtha product stream, providing the desulfurized product stream,
wherein the conditions and catalytically active material of steps (x) and (z) may be similar or different with the associated benefit tailoring the catalytically active material of steps (x) and (z) to the relevant requirements for conversion of sulfur, and with the associated benefit of removing hydrogen sulfide which may interfere with the hydrodesulfurization of step (z).

In a further embodiment said step (x) converts at least 75%, 80% or 85% of the organically bound sulfur to H₂S, with the associated benefit of the high GOR and/or H2OR of the process allowing such a severe HDS step, while avoiding excessive saturation of olefins.

In a further embodiment said step (y) is present and involves the steps (p) separating the desulfurized heavy product stream in at least a desulfurized heavy naphtha stream, a desulfurized intermediate naphtha stream and a gas stream, and one or both of the steps:
(q) further desulfurizing the intermediate desulfurized naphtha product stream, providing the intermediate desulfurized product stream; and
(r) combining two or more of the intermediate desulfurized product stream, the heavy desulfurized product stream, the light naphtha stream and the light desulfurized naphtha stream to form a final product stream, with the associated benefit of providing even more possibility to fine tune the materials and conditions of the process.

In a further embodiment the process for hydrodesulfurizing the olefinic naphtha feedstock retains at least 20%, 40%, 60% or 80% of the olefins in the olefinic naphtha feedstock with the associated benefit of such a process providing a hydrocarbon being useful as a component in a high octane low sulfur gasoline.

In a further embodiment the process further comprises a step of selective diolefin hydrogenation prior to said hydrodesulfurizing step, with the associated benefit of reducing the risk of polymerization of diolefins in the process and of reacting olefins and mercaptans to convert low-boiling mercaptans to higher boiling sulfides. The reaction between olefins and mercaptans has the effect of providing a light naphtha fraction comprising olefins and little or no sulfur and a heavy naphtha fraction comprising few olefins and the majority of sulfur. Such two fractions may be separated and treated individually.

In a further embodiment, the selective diolefin hydrogenation reaction conditions involves a temperature from 80° C., 90° C., 100° C. or 150° C. to 200° C., a pressure from 2 barg or 5 barg to 40 barg or 50 barg, and gas to oil ratio from 2 Nm³/m³, 5 Nm³/m³ or 10 Nm³/m³ to 20 Nm³/m³ or 25 Nm³/m³ to convert at least 80% or 90% of the diolefins to alkanes or monoolefins or by reaction with mercaptans to sulfides, with the associated benefit of such conditions being effective in hydrogenation of diolefins, with minimal mono-olefin saturation, and thus minimal RON loss. In addition, the conditions are effective in formation of sulfides from mercaptans and olefins, which has the potential effect of providing a light naphtha fraction comprising olefins and little or no sulfur and a heavy naphtha fraction comprising few olefins and the majority of sulfur. This difference in characteristics between light naphtha fraction and heavy naphtha fraction may be employed in specific treatment of the two fractions.

In a further embodiment the selective diolefin hydrogenation reaction conditions involve a temperature from 80° C., 90° C. or 100° C. to 200° C., a pressure of 5 barg to 40 barg or 50 barg, and a gas to oil ratio of 250 Nm³/m³ to 2500 Nm³/m³ to convert at least 80% or 90% of the diolefins to alkanes or mono-olefins or by reaction with mercaptans to sulfides, with the associated benefit of such a process not requiring separate hydrogen addition in the diolefin hydrogenation and hydrodesulfurizing steps.

The rate of a chemical process is controlled by chemical kinetics. Typically, reaction rates increase with increased temperature, increased reactant concentration, decreased product concentration and decreased space velocities (i.e. increased residence times), but the relations may be more complex than expected, due to the nature of reaction mechanisms on the microscopic level. Especially in refinery processes, increasing the factors which increase reaction rates will be called increased severity of the process.

Hydrogenation processes are often employed in the conversion of hydrocarbons, e.g. for the removal of sulfur by hydrodesulfurization (HDS). The severity of hydrogenation is typically increased by increasing temperature, hydrogen partial pressure, the gas to oil ratio (GOR) or decreasing the space velocity.

A common intermediate product in refineries is naphtha withdrawn from a fluid catalytic cracker, which is suitable for use as gasoline. The amount of sulfur in this FCC naphtha is typically too high to be included in final gasoline product, and the sulfur is often reduced by hydrotreatment, but at the same time it is desired that the amount of olefins is maintained, as removal of these would lead to a reduced octane number of the final gasoline product. As desulfurization as well as olefin saturation are hydrogenation processes the immediate expectation is that increasing the hydrogenation severity to obtain a high extent of HDS will be associated with a high sacrifice of octane number due to olefin saturation. A further aspect of FCC naphtha post-treat is that the presence of di-olefins is undesired, as diolefins, which may be present in a concentration from 0.1%, 0.5% or 1% to around 5%, may polymerize and form solid products which will block the reactor.

The strategy for balancing a high diolefin saturation, a high HDS activity and a low olefin saturation has often been based on specific process conditions in combination with the choice of selective catalysts. For the diolefin-hydrogenation a nickel-molybdenum catalyst operating at low GOR and low temperature has been preferred, since the less severe conditions will not result in high hydrogenation of mono-olefins. EP 0 725 126 propose to split the FCC naphtha to be desulfurized in a light and a heavy naphtha stream, and treat these differently—e.g. by only hydrotreating the heavy naphtha stream, which will have the highest amount of sulfur, or by hydrotreating the heavy naphtha stream in two steps with or without intermediate separation. Often the first hydrotreatment step is carried out in the presence of a cobalt/molybdenum catalyst, which is more active in HDS than in olefin saturation.

Recent environmental standards require the sulfur content to be as low as 10 ppm in gasoline. To obtain this for a feed with 1000 ppm sulfur as much as 99% HDS will be required. It is well known that this may be obtained by increasing the severity of the HDS process by increasing the temperature or hydrogen partial pressure. This increase in temperature or hydrogen partial pressure will however have the drawback of also increasing the olefin saturation, such that the octane number and thus the gasoline value is reduced.

Similarly, the decrease of space velocity may also result in increased HDS, but also in this situation a sacrifice of octane number is observed.

According to the prior art, the GOR for HDS of FCC naphtha has typically been 300 Nm³/m³ to 500 Nm³/m³, but studies of the effect of varying GOR have not been made. Increasing GOR has however been considered an increase of hydrotreatment severity, and therefore a common expectation has been that increased GOR would result in increased rates of other hydrogenation processes. The experiments in the present document, evidence that a process in which GOR is above 500 Nm³/m³ results in increased HDS without increasing olefin saturation; on the contrary a reduction in olefin saturation is observed. This surprising experimental observation may be implemented in a novel and inventive process, involving operation of a HDS reactor at a combination of moderately increased GOR, such as above 500 Nm³/m³, 600 Nm³/m³ or 700 Nm³/m³ and lower pressures than practiced in the prior art. Beneficially an upper limit, such as 1000 Nm³/m³ may be imposed on the GOR, as this will limit equipment size.

The analysis of experimental data has identified that it is possible to reach previously unrealized values of selectivity above 10 and even 20, by reducing the pressure in the process, especially in combination with high GOR. Without being bound by theory it is believed that the effect is due to a combination of low pressure limiting olefin saturation as well as mercaptan recombination and the high GOR limiting catalyst deactivation.

However, increasing the GOR is associated with drawbacks, such as excessive volume of process equipment as well as excessive requirements for e.g. compressor capacity, and therefore it is preferred to operate with a GOR below 1000 Nm³/m³.

In addition, the realization of high selectivities at moderate conversion and thus low severity opens a previously unrealized opportunity for increasing the window of operation by choosing a low space velocity, such as 1.1 hr⁻¹ to 3 hr⁻¹.

It has further been identified that an appropriate evaluation of the balance between high HDS conversion and low olefin saturation may beneficially be made by plotting selectivity (% HDS/% OSAT) vs. (100-% HDS), which in the interval of severity defined by % HDS being 60% to 99%. These experimental data were observed to have a linear correlation with an asymptotic selectivity of 1 at high severity with 100% HDS, and therefore to follow the correlation (% HDS/% OSAT)=aᵢ*(100-% HDS)+1, where aᵢ is a constant corresponding to combination (i) of conditions, such as feedstock, GOR, pressure and catalyst, but varying severity. This surprising realization lead to the identification of the parameter “selectivity slope” aᵢ=(% HDS-% OSAT)/(% OSAT*(100-% HDS)), which due to the linear nature of the correlation may be used to characterize a single set of conditions as highly selective, irrespectively of the chosen severity (within the severity range defined by % HDS between 60% and 99%).

According to the present disclosure it is therefore recommended to evaluate process selectivity by the parameter “selectivity slope” and to optimize the selectivity slope by varying GOR and pressure, with increasing GOR and decreasing pressure leading to increased selectivity slope.

It has been surprisingly identified that a previously unrealized potential for a good process performance, as shown by a steep selectivity slope above 0.55 or 0.7, may be obtained for difficult feedstocks of which less than e.g. 30% or 50% of the sulfur is in the form of mercaptans. Such a moderate content of mercaptans would typically be found in FCC products, not having undergone significant hydrodesulfurization.

Reducing sulfur content while having low or no reduction of octane number, by a high GOR and a low pressure has the benefit that complex process layouts may be avoided or that it is made possible to obtain very low sulfur levels in combination with satisfactory octane numbers, which would otherwise be hard to obtain. It may however also be found beneficial to combine a process with a high GOR and low pressure with the existing process designs, such as an initial hydrogenation of diolefins, a separation of heavy and light naphtha streams, and treatment of one or both of these streams, in one or more steps. Some or all of the process steps involving hydrodesulfurisation may be carried out at increased GOR and low pressure in accordance with the present disclosure.

The hydrogenation of diolefins is preferably carried out at moderate conditions. The reason is that the hydrogenation of the first double bond in diolefins is readily carried out at low temperature, and by limiting the temperature the second double bond may be protected. Therefore, the GOR are kept very low, typically below 25 Nm³/m³, 10 Nm³/m³ or even 5 Nm³/m³, but also temperature is kept low, e.g. around 100° C.-200° C. The GOR must however be sufficient for the desired saturation of diolefins present.

The present disclosure also include combination of the aspects and embodiments listed above.

### BRIEF DESCRIPTION OF THE FIGURES

FIG. 1 shows a simple process, implementing the present disclosure.

FIG. 2 shows an implementation of the present disclosure in a process involving pretreatment and separation.

FIG. 3 shows experimental data presented as olefin saturation vs. hydrodesulfurization.

FIG. 4 shows experimental data presented as selectivity vs. 100%—hydrodesulfurization, together with linear fits of the experimental data.

102 Hydrocarbon feedstock
104 Stream of hydrogen containing gas
106 Combined feedstock
108 Material catalytically active in hydrodesulfurization
110 Desulfurized naphtha stream
202 Di-olefinic hydrocarbon feedstock
204 Hydrogen containing gas
206 Di-olefinic feedstock reaction mixture
208 Material catalytically active in diolefin saturation
210 Intermediate product
212 Separator
214 Light naphtha stream
216 Heavy naphtha stream
218 Hydrogen containing gas
220 Heavy naphtha reaction mixture
222 First material catalytically active in hydrodesulfurization
222 Material catalytically active in hydrodesulfurization
224 Partly desulfurized heavy naphtha
226 Further catalytically active material
228 Desulfurized heavy naphtha
230 Desulfurized naphtha product

### DETAILED DESCRIPTION

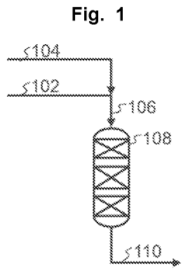

FIG. 1 shows a process for removing organically bound sulfur from hydrocarbons. The process involves combining a hydrocarbon feedstock 102 containing organically bound sulfur and olefins with a stream of hydrogen containing gas 104 such that the ratio of hydrogen containing gas to feedstock is at least 750 Nm³/m³. The combined feedstock 106 is directed to contact a material catalytically active in hydrodesulfurization 108, such as 1% cobalt and 3% molybdenum, on an alumina support, at a temperature around 250° C. A desulfurized naphtha stream 110 is withdrawn from the catalytically active material.

In a further embodiment the catalytically active material may have a different composition such as 1% to 5% cobalt and 3% to 20% molybdenum or tungsten, on a refractory support, which may be alumina, silica, spinel or silica-alumina.

In a further embodiment the hydrogen containing gas may comprise significant amounts of other gases, e.g. more than 25%, 50% or even 75% nitrogen, methane, ethane or mixtures hereof.

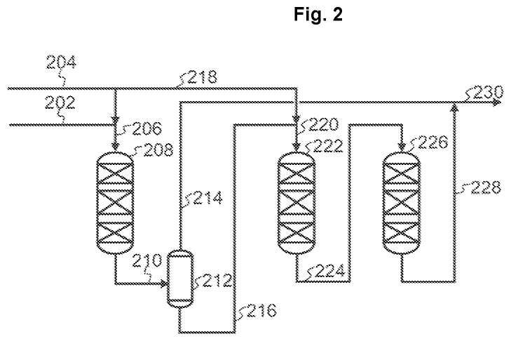

FIG. 2 shows a process for removing organically bound sulfur from hydrocarbons comprising di-olefins. The process involves combining a di-olefinic hydrocarbon feedstock 202 containing organically bound sulfur, olefins and diolefins with a stream of hydrogen containing gas 204 such that the ratio of hydrogen containing gas to feedstock is around 5-10 Nm³/m³ providing a di-olefinic feedstock reaction mixture 206. The di-olefinic feedstock reaction mixture 206 is directed to contact a material catalytically active in diolefin saturation 208, such as 2% nickel or cobalt and 7% molybdenum or tungsten, on an alumina support, at a temperature around 100-200° C., to provide an intermediate product 210 comprising less than 0.1% or 0.3% di-olefins. Under such mild conditions, it is considered that the lighter sulfur components of the di-olefinic hydrocarbon feedstock do not react to release organic sulfur as H₂S, but instead they may undergo recombination reactions with olefins to form heavier sulfides. The intermediate product 210 is directed to a separator 212, from which a light naphtha stream 214 and a heavy naphtha stream 216 are withdrawn. The heavy naphtha stream 216 is combined with a stream of hydrogen containing gas 218 such that the ratio of hydrogen containing gas to feedstock in the resulting heavy naphtha reaction mixture 220 is at least 750 Nm³/m³ and directed to contact a first material catalytically active in hydrodesulfurization 222, such as 1% cobalt and 3% molybdenum, on an alumina support, at a temperature around 250° C., providing a partly desulfurized heavy naphtha 224. The partly desulfurized heavy naphtha 224 may optionally be directed to a further catalytically active material 226 such as 12% nickel on an alumina support, typically operating at a temperature higher than the first material catalytically active in hydrodesulfurization 222, such as 300° C. to 360° C., providing a desulfurized heavy naphtha 228. The desulfurized heavy naphtha 228 is then combined with the light naphtha stream 214 to provide a desulfurized naphtha product 230. In FIG. 1 and FIG. 2 the temperature control of the reactions are not shown, but since the HDS reactions are exothermic, it is typical to add cold hydrogen containing gas or cold recycled product to maintain a low temperature increase. If the GOR is increased the requirement for using product recycle may be reduced, as more quench gas will be available.

In a further embodiment the light naphtha may also be desulfurized by contact with a material catalytically active in hydrotreatment, but typically at less severe conditions than the heavy stream(s).

In a further embodiment the partly desulfurized heavy naphtha may be directed to a separator to provide the heavy sulfurized naphtha fraction contacting the third catalytically active material and an intermediate naphtha fraction which may either be treated by contact with a further catalytically active material or be combined into the desulfurized naphtha product.

### EXAMPLES

Two feedstocks of commercial, heavy catalyst cracked naphtha boiling between 60 and 200° C. were directed to hydrodesulfurization in an isothermal downflow pilot plant reactor. The feedstocks are characterized in Table 1 and Table 2. The hydrodesulfurization conditions in the reactor are further specified below.

The reactor effluent was cooled to ca. −5° C. to condense the treated naphtha product, which was separated from a remaining gas phase comprising H₂S and unreacted H₂, and subsequently stripped using N₂ to remove any dissolved H₂S from the product. The catalyst used was a hydrodesulfurization catalyst comprising 1.1 wt % Co and 3.2 wt % Mo on alumina support. The catalyst was a 1/20 inch trilobe size in Example 1 and a 1/10 inch quadlobe size in the remaining examples.

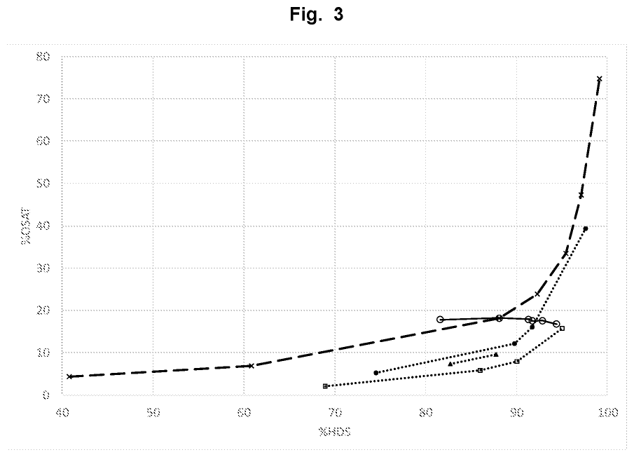

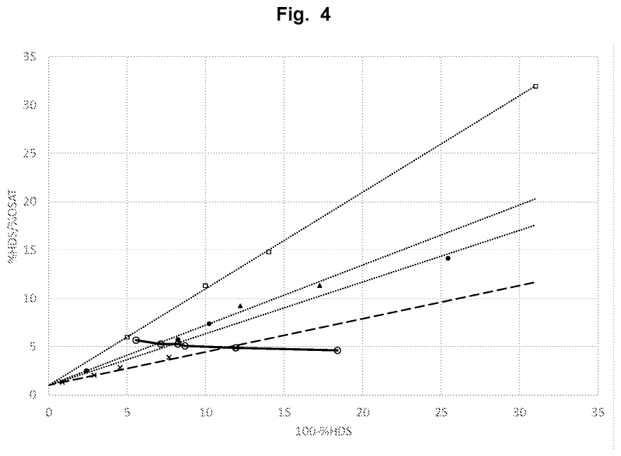

The experimental results are listed in Table 3 to Table 7, and depicted in FIG. 3 and FIG. 4.

FIG. 3 plots % OSAT vs. % HDS. The attractive region of parameters of high % HDS and low % OSAT is proximate to the lower right corner.

FIG. 4 plots selectivity (% OSAT/% HDS) vs. 100-% HDS. Here the attractive region of parameters corresponds to the steepest line, especially to the top left. For each set of experiments a linear fit is made, with intercept forced to 1, corresponding to a selectivity of 1 for maximum severity. For each individual experiment the corresponding value of selectivity slope between the experimental point and the point ((% OSAT/% HDS), (100-% HDS))=(0,1) is calculated as (% HDS-% OSAT)/(% OSAT*(100-% HDS)) and included in the tables reporting the experiments.

### Example 1

In Example 1 Feedstock 1 was treated under a GOR level of 500 Nm³/m³, with 100% hydrogen treat gas. The severity of hydrodesulfurization was controlled by varying the temperature from 200 to 280° C. and the gas to feedstock ratio (GOR) of 250 to 1400 Nm³/m³, with an inlet pressure of 20 barg. The liquid hourly space velocity (LHSV) was 2.5 1/hr (v/v/hr). Experimental results are shown in Table 3, and in FIGS. 3 and 4 using the symbol ‘x’.

### Example 2

In Example 2 Feedstock 2 was treated under a GOR level of 1200 Nm³/m³ with 100% hydrogen treat gas with an inlet pressure of 20 barg. The severity of hydrodesulfurization was controlled by varying the temperature from 220 to 265° C. The liquid hourly space velocity (LHSV) was 2.5 1/hr (v/v/hr). Experimental results are shown in Table 4, and in FIGS. 3 and 4 using the closed circle symbol ‘•’.

### Example 3

In Example 3 Feedstock 2 was treated under a GOR level of 1200 Nm³/m³ with a treat gas mixture of H₂ and CH₄ with a total inlet pressure of 20 barg. The severity of hydrodesulfurization was controlled by varying the H₂ concentration in the treat gas from 42% to 75%. The temperature was 235° C. The liquid hourly space velocity (LHSV) was 2.5 1/hr (v/v/hr). Experimental results are shown in Table 5, and in FIGS. 3 and 4 using the closed triangle symbol ‘▴’.

### Example 4

In Example 4 Feedstock 2 was treated under a GOR level of 1200 Nm³/m³ with a 100% hydrogen treat gas with an inlet pressure of 8.3 barg. The severity of hydrodesulfurization was controlled by varying the temperature from 220 to 265° C. The liquid hourly space velocity (LHSV) was 2.5 1/hr (v/v/hr). Experimental results are shown in Table 6, and in FIGS. 3 and 4 using the open square symbol ‘□’.

### Example 5

In Example 5 Feedstock 1 was treated under a GOR level varying from 250 Nm³/m³ to 1200 Nm³/m³ with a 100% hydrogen treat gas with an inlet pressure of 20 barg and a temperature of 230° C. The severity of hydrodesulfurization was not varied further. The liquid hourly space velocity (LHSV) was 2.5 1/hr (v/v/hr). Experimental results are shown in Table 7, and in FIGS. 3 and 4 using the open circle symbol ‘∘’.

The results of Example 4 and Example 5 in combination indicate that it will be possible to obtain attractive high selectivity conditions, while avoiding excessive equipment cost, by operating at GOR below 1000 Nm³/m³ and at low pressures.

Analyzing the experimental results by the direct inspection using FIG. 3 shows that Example 4 at low pressure and high GOR operate in the more desirable range of high % HDS and low % OSAT, while Example 1 according to the prior art at low GOR and high pressure is the least desirable. Examples 2 and 3 are similar to each other with a position between the other two experiments.

FIG. 4 shows a transformed representation of the experimental results, by plotting selectivity (% HDS/% OSAT) vs. % HDS for the experiments where % HDS is above 60. The parameters of the fitted lines are shown in Table 8, for a two-parameter fit of slope and intercept and for a linear fit with intercept forced to 1. In FIG. 4 the lines with intercept 1 is shown to benefit the comparison of lines.

The low conversion experiments (two experiments of Example 1) were omitted as they deviated from the linear trend, with a selectivity slope far below the other experiments of Example 1.

Example 3 indicate that keeping the absolute pressure, while reducing partial pressure has an effect upon selectivity similar to changing severity by changing temperature. A comparison of Example 3 and 4 indicate that for conditions with the same partial pressure of hydrogen (42% hydrogen at 20 barg vs. 100% hydrogen at 8.3 barg), selectivity slope is higher when the absolute pressure is lower.

Table 8 shows that for Examples 4 according to the present invention the slope is close to 1, and much higher than for Examples 1, 2 and 3. This documents that operation at high GOR and low pressure provides an optimal parameter space in which the desired selectivity for % HDS over % OSAT is possible, and furthermore that this optimal parameter space is conveniently identified by evaluating the slope of selectivity assuming an asymptotic selectivity of 1 at 100% HDS. The assumption of an asymptotic selectivity also has the convenience that a measure of the quality of conditions may be estimated from a single experiment and calculated as (% HDS-% OSAT)/(% OSAT*(100-% HDS)). From Tables 3 to 7 it is seen that the selectivity slope varies little with severity within similar experiments. The high intercept value for Example 3, is considered to an artefact due to statistical uncertainty, and as shown in Table 5 the selectivity slope values for the two experiments are consistent, confirming the appropriateness of using the selectivity slope parameter. It is seen that for moderate GOR, only experiments with low absolute pressure have values above 0.55.

TABLE 1
Feedstock

| Property | Method of Analysis | |
|---|---|---|
| Sulfur | ASTM D 4294 | 250 ppmw |
| SG 60/60° F. | ASTM D 4052 | 0.7605 |
| Olefin | ASTM D 6839 | 35 w % |
| RON | ASTM D 2699 | 89.8 |

ASTM D 7213

| | |
|---|---|
| Boiling point | SimDist |

| | |
|---|---|
| IBP | 37° C. |
| 5% | 62° C. |
| 10% | 71° C. |
| 50% | 117° C. |
| 95% | 173° C. |
| FBP | 201° C. |

TABLE 2
Feedstock

| Property | Method of Analysis | |
|---|---|---|
| Sulfur | ASTM D 4294 | 249 ppmw |
| SG 60/60° F. | ASTM D 4052 | 0.7517 |
| Olefin | ASTM D 6839 | 35 w % |
| RON | ASTM D 2699 | 90.7 |
| | ASTM D 6729 | |
| Boiling point | DHA | |
| IBP | −3.4° C. | |
| 10 wt % | 49° C. | |
| 20 wt % | 69° C. | |
| SO wt % | 115° C. | |
| 90 wt % | 166° C. | |
| FBP | 189° C. | |

TABLE 3

| Temperature | Pressure | | % | % | % Olefin | Selectivity |
|---|---|---|---|---|---|---|
| [° C.] | (barg) | GOR | H2 | HDS | Saturation | slope |
| 200 | 20.0 | 502 | 100 | 41 | 4 | 0.14 |
| 210 | 20.0 | 502 | 100 | 61 | 7 | 0.20 |
| 230 | 20.0 | 502 | 100 | 88 | 18 | 0.32 |
| 240 | 20.0 | 502 | 100 | 92 | 24 | 0.37 |
| 250 | 20.0 | 502 | 100 | 95 | 34 | 0.41 |
| 260 | 20.0 | 502 | 100 | 97 | 47 | 0.36 |
| 280 | 20.0 | 502 | 100 | 99 | 75 | 0.38 |

TABLE 4

| Temperature | Pressure | | | | % Olefin | Selectivity |
|---|---|---|---|---|---|---|
| [° C.] | (barg) | GOR | % H2 | % HDS | Saturation | slope |
| 220 | 20.0 | 1200 | 100 | 75 | 5 | 0.52 |
| 235 | 20.0 | 1204 | 100 | 90 | 12 | 0.62 |
| 235 | 20.0 | 1200 | 100 | 92 | 16 | 0.58 |
| 265 | 20.0 | 1200 | 100 | 98 | 39 | 0.61 |

TABLE 5

| Temperature | Pressure | | | | % Olefin | Selectivity |
|---|---|---|---|---|---|---|
| [° C.] | (barg) | GOR | % H2 | % HDS | Saturation | slope |
| 235 | 20.0 | 1200 | 42 | 83 | 7 | 0.60 |
| 235 | 20.0 | 1200 | 63 | 88 | 10 | 0.67 |

TABLE 6

| Temperature | Pressure | | | | % Olefin | Selectivity |
|---|---|---|---|---|---|---|
| [° C.] | (barg) | GOR | % H2 | % HDS | Saturation | slope |
| 220 | 8.3 | 1200 | 100 | 69 | 2 | 1.00 |
| 235 | 8.3 | 1200 | 100 | 86 | 6 | 0.98 |
| 245 | 8.3 | 1200 | 100 | 90 | 8 | 1.04 |
| 265 | 8.3 | 1203 | 100 | 95 | 16 | 1.00 |

TABLE 7

| Temperature | Pressure | | | | % Olefin | Selectivity |
|---|---|---|---|---|---|---|
| [° C.] | (barg) | GOR | % H2 | % HDS | Saturation | slope |
| 230 | 20.0 | 252 | 100 | 82 | 18 | 0.19 |
| 230 | 20.0 | 502 | 100 | 88 | 18 | 0.32 |
| 230 | 20.0 | 752 | 100 | 91 | 18 | 0.47 |
| 230 | 20.0 | 904 | 100 | 92 | 18 | 0.51 |
| 230 | 20.0 | 1104 | 100 | 93 | 18 | 0.60 |
| 230 | 20.0 | 1405 | 100 | 94 | 17 | 0.83 |

TABLE 8

| | Slope | Intercept | Slope w. intercept = 1 |
|---|---|---|---|
| Example 1 | 0.320 | 1.2 | 0.345 |
| Example 2 | 0.497 | 1.7 | 0.534 |
| Example 3 | 0.417 | 4.1 | 0.622 |
| Example 4 | 0.991 | 1.1 | 0.997 |

1. A process for hydrodesulfurizing an olefinic naphtha feedstock while retaining a substantial amount of the olefins, which feedstock has a T₉₅ boiling point below 250° C. and contains at least 50 ppmw of organically bound sulfur and from 5% to 60% olefins, said process comprising:
(a) hydrodesulfurizing the feedstock in a sulfur removal stage in the presence of a gas comprising hydrogen and a hydrodesulfurization catalyst, at hydrodesulfurization reaction conditions including a temperature from 200° C. to 350° C., a pressure from 2 barg to 35 barg, and gas to oil ratio from 500 Nm³/m³ to 1000 Nm³/m³, to convert at least 60% of the organically bound sulfur to hydrogen sulfide and to produce a desulfurized product stream.

2. A process according to claim 1 wherein the process severity is configured for converting at least 70% of the organically bound sulfur to hydrogen sulfide.

3. A process according to claim 1, wherein the gas to oil ratio and the pressure is configured for the selectivity slope, (% HDS-% OSAT)/(% OSAT*(100-% HDS)), to be above 0.55.

4. A process according to claim 3, wherein less than 30% of the sulfur in the feedstock directed to the sulfur removal stage is found in mercaptans.

5. A process according to claim 1, wherein the liquid hourly space velocity is from 1.1 hr⁻¹ to 3 hr⁻¹.

6. A process according to claim 1, further comprising the steps of:
(b) separating the feedstock in at least a heavy naphtha stream and a light naphtha stream according to boiling point;
(c) directing said heavy naphtha stream as the feedstock of said hydrodesulfurizing step, providing a desulfurized product stream;
(d) optionally directing the light naphtha stream as the feedstock to a further sulfur removal stage, providing a light desulfurized naphtha stream; and
(e) combining said desulfurized product stream and either said light naphtha stream or said light desulfurized naphtha stream to form a final product stream.

7. A process according to claim 1, in which said hydrodesulfurization catalyst comprises 0.5% to 5% cobalt and/or nickel and 3% to 20% molybdenum and/or tungsten, on a refractory support.

8. A process according to claim 7, in which said hydrodesulfurization catalyst comprises 0.5% to 5% cobalt and 3% to 20% molybdenum.

9. A process according to claim 7, in which refractory said support comprises alumina, silica or silica-alumina.

10. A process according to claim 6, wherein said step (c) comprises the substeps:
(x) directing said heavy naphtha stream as the feedstock of a first hydrodesulfurizing step in the presence of a catalytically active material, providing a desulfurized heavy product stream;
(y) optionally separating the desulfurized heavy product stream into at least a desulfurized heavy naphtha stream and a gas stream; and
(z) further desulfurizing the heavy desulfurized naphtha product stream in the presence of a catalytically active material, providing the desulfurized product stream,
wherein the conditions and catalytically active material of steps (x) and (z) may be similar or different.

11. A process according to claim 10, wherein said step (x) converts at least 75% of the organically bound sulfur to H₂S.

12. A process according to claim 10, wherein said step (y) is present and involves the steps:
(p) separating the desulfurized heavy product stream in a at least a desulfurized heavy naphtha stream, desulfurized intermediate naphtha stream and a gas stream, and one or both of the steps;
(q) further desulfurizing the desulfurized intermediate naphtha product stream, providing the intermediate desulfurized product stream; and
(r) combining two or more of the intermediate desulfurized product stream, the heavy desulfurized product stream, said light naphtha stream and said light desulfurized naphtha stream to form a final product stream.

13. A process according to claim 1, wherein the process for hydrodesulfurizing the olefinic naphtha feedstock retains at least 20% of the olefins in the olefinic naphtha feedstock.

14. A process according to claim 1, further comprising a step of selective diolefin hydrogenation prior to said hydrodesulfurizing step.

15. A process according to claim 14, in which the selective diolefin hydrogenation reaction conditions of said selective diolefin hydrogenation involves a temperature from 80° C. to 200° C., a pressure from 5 barg to 50 barg, and a gas to oil ratio from 2 Nm³/m³ to 250 Nm³/m³ to convert at least 80% of the diolefins to alkanes or mono-olefins or by reaction with mercaptans to sulfides.

16. A process according to claim 14, in which the selective diolefin hydrogenation reaction conditions involves a temperature from 100° C. to 130° C., a pressure of 5 barg to 50 barg, and a gas to oil ratio of 250 Nm³/m³ to 2500 Nm³/m³ to convert at least 80% of the diolefins to alkanes or mono-olefins or by reaction with mercaptans to sulfides.
